(19) United States
(12) Patent Application Publication
(10) Pub. No.: US 2008/0315626 A1
(43) Pub. Date: Dec. 25, 2008

(54) Passive Protection Device for a Motor Vehicle

(76) Inventors: Frank Lutter, Leverkusen (DE); Boris Koch, Leverkusen (DE); Ralf Zimnol, Leverkusen (DE); Ulrich Grosser, Leverkusen (DE); Martin Klocke, Leverkusen (DE); Ulrich Dajek, Leverkusen (DE); Alexander Ickes, Ingolstadt (DE); Anja Jaschke, Ingolstadt (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/065,440

(22) PCT Filed: Jun. 21, 2006
(86) PCT No.: PCT/EP2006/063398

§ 371 Date: Sep. 2, 2008

(30) Foreign Application Priority Data
Aug. 30, 2005 (DE) 102005041161.4
Apr. 25, 2006 (DE) 102006019648.1

(51) Int. Cl. B60R 21/34

(52) U.S. Cl. 296/187.04; 296/193.01; 296/187.03; 296/187.09

(57) ABSTRACT

A device for the reduction of injuries in the event of a motor-vehicle accident comprises an adapter inserted between the vehicle bodywork and adjacent internal vehicle components to reduce the free space distance between the bodywork and the components. The free space distance is the shortest direct distance between a vehicle component and the adjacent bodywork which is free from other parts. The adapter changes the energy transfer involved in a collision between a person and the vehicle, in order to reduce the risk of injury to the head.

The invention relates to a device for the reduction of injuries in the event of a motor-vehicle accident.

When a pedestrian or passer-by is struck by a motor vehicle, injuries result from the impact between the person and the bodywork of the motor vehicle. In Europe, some 7000 pedestrians per year lose their lives as a result of collisions of this kind with passenger vehicles. The majority of fatalities are caused by injuries to the head. According to accident statistics, the cause of death in 80% of all fatal injuries to pedestrians was the head striking the engine hood or the A-pillars. In 95% of these collisions, the speed of the vehicle was below 60 km/h; the statistical mean was around 40 km/h.

In order to reduce these fatalities, motor vehicles should be designed in such a manner that, in the event of a collision between a pedestrian and a vehicle moving at 40 km/h, the so-called head-injury-criterion (HIC-value) is less than 1000 over an exactly-defined two thirds of the surface area of an engine hood and less than 2000 over the remaining one third. The HIC-value is obtained by calculating the acceleration and deceleration of the head over the exposure time. A calculation of the HIC-value known to the person skilled in the art is as follows:

$$H I {C}_{36} = {MAX}_{( t 2 - t 1 ) \leq 36 ms} \{ {( {t}_{2} - {t}_{1} ) [ \frac{1}{( {t}_{2} - {t}_{1} )} {\int }_{{t}_{1}}^{{t}_{2}} a d t ]}^{5 / 2} \}$$

$$t = \frac{Time}{1 sec}$$

$$a = \frac{Acceleration \text{-} of \text{-} head}{Acceleration \text{-} due \text{-} to \text{-} gravity}$$

$$36 ms = time \text{-} window$$

The HIC-value is used internationally as a parameter for the severity of head injuries. For example, with an HIC-value of 1000, the risk of life-threatening injury is 15%; with a value of 2000, the risk increases to 90%.

Technically-complex protective devices for the reduction of this problem have already been developed. A front hood, which is slightly raised within milliseconds, and two inflatable airbags positioned in front of the windshield are supposed to save lives. If a pedestrian's leg comes into contact with a sensor integrated in the bumper, two steel folding bellows powered by gas generators raise the rear part of the engine hood by approximately 10 centimetres within 70 milliseconds. This increases the deformation distance of the hood, thereby reducing the intensity of impact with the head. At the same time, the pedestrian is prevented from colliding with the lower region of the front windshield. In a second step, the efficacy of the system is further increased by the inflation of an airbag respectively on the right and left in front of the windshield frame, that is to say, in front of the so-called A-pillars. These special airbags are constructed in a similar manner to an inflatable mattress and accordingly distribute the impact energy over a relatively large area. In this manner, even at relatively fast impact velocities and in spite of the fact that the airbags are comparatively small with a volume of only 7 litres, the head is prevented from breaking through the windshield. A protective system of this kind is supplied, for example, by the Swedish company Autoliv.

The idea of the solutions described above is associated with the risk, that the airbag or the raising of the engine hood could be activated accidentally, which could cause accidents. Moreover, the solution is technically complex and expensive.

The object of the invention is to provide a device for a motor vehicle, which substantially reduces the potential risk of injury in the event of an accident.

In order to achieve the object, an adapter, which reduces the free space distance between internal vehicle components and the vehicle bodywork, is inserted between the vehicle bodywork and internal vehicle components disposed within and adjacent to the vehicle bodywork. In particular, for the reasons named below, the adapter is a structure, which is crumbled or splintered and/or kinked or folded in the event of a collision with a head. The structure is, for example, a part of a front hood.

In the event of a collision between a vehicle bodywork consisting of sheet steel, aluminium or synthetic material and a pedestrian, the flexibility of the vehicle bodywork is generally sufficient to avoid a fatal outcome from the collision. However, vehicle components, such as an engine block or sub-frame structures such as bearers, which limit the deformation distance of the vehicle bodywork, are generally disposed in the interior, adjacent to the outer skin of the vehicle bodywork. Generally-fatal HIC-values are reached only if the vehicle bodywork, deforming as a result of a collision, comes into contact with a vehicle component of this kind.

It has now surprisingly been established, that the HIC-value can be decreased by providing an adapter, which reduces the free space distance between the vehicle bodywork and a vehicle component of this kind. A free space distance in the meaning of the invention is the shortest, direct distance between a vehicle component and the adjacent vehicle bodywork, which is free from other parts.

With such an adapter, the energy resulting from the collision is transferred to a pedestrian or person at an earlier time. Accordingly, the person or the person's head experiences a strong braking effect at an earlier time. The HIC-value is improved, because a maximum acceleration comes into effect sooner after the impact and then subsides or passes through the pedestrian's head particularly rapidly. It has been shown, that the HIC-value is reduced as a result of the earlier transfer of energy achieved in this manner, even if a stronger impulse or a greater maximum acceleration occurs for a short time as a result of the earlier braking effect.

The invention is based upon the idea of ensuring that the acceleration and associated transfer of energy, in the case of internal vehicle components disposed adjacent to the vehicle bodywork, does not act over a relatively long period of time and with a relatively flat gradient, but rather that the maximum of the acceleration or respectively of the energy transfer is reached as soon as possible.

In order to reduce the potential risk, the adapter in one embodiment provides a structure, which is crumbled, splintered and/or kinked or folded in the event of a collision. This ensures that the energy released in the event of an impact initiates the crumbling and/or kinking and is therefore reduced immediately after reaching a brief maximum. This keeps the duration of the energy transfer short, but the time of maximum energy transfer is reached very early. Accordingly, the HIC-value is reduced.

In order to provide a structure, which transfers energy as quickly as possible but then in a rapidly declining manner as a result of kinking, the structure provides ribs, which are disposed substantially at right angles to the vehicle bodywork. If a pedestrian's head strikes the vehicle bodywork, these ribs are kinked. The available kinetic energy therefore initially causes the kinking, and at this moment, a relatively large quantity of energy is also transferred to the pedestrian's head. However, immediately following this, the energy-transfer curve rapidly declines, because the kinked ribs now offer a reduced resistance.

Alternatively or additionally, a comparable effect can be achieved with a crumbling structure. In this context, if a pedestrian's head strikes the vehicle bodywork, the structure crumbles. The energy occurring in the collision therefore initially causes the crumbling, so that a relatively-large quantity of energy is transferred to the pedestrian at this moment. However, the energy-transfer curve rapidly declines immediately following this.

The rib structure, disposed substantially at right angles to a vehicle bodywork may also consist of a material which crumbles in the event of a collision. The desired energy-transfer curve is achieved particularly well in this manner, because the structure “crumbles with kinking”. The ribs are preferably distributed evenly over the surface of the adapter in order to achieve the desired reduction of the HIC-value independently of the site of the impact.

In order to induce the desired kinking and/or crumbling effect in a defined manner, a slightly zigzag-shaped rib structure can also be provided, thereby inducing the kinking or folding in a planned and predictable manner. In this case, the main direction of the rib structure once again extends substantially perpendicular to the surface of the adjacent vehicle bodywork, the adjacent vehicle bodywork being formed, in particular, by the front hood.

Materials which can crumble or splinter within the meaning of the invention are glass, brittle synthetic materials such as duroplastics, thermoplastics and reinforced thermoplastics, metals such as aluminium or magnesium manufactured by pressure casting with a ductile yield of a few percent. The ductile yield, which these materials should provide, is, for example, up to 10%, advantageously up to 5%.

The behaviour of brittle materials can be adjusted only in a relatively poorly-reproducible manner. In one embodiment of the invention, tougher materials are therefore preferred, which provide a significantly-higher ductile yield, preferably more than 50%. Appropriate metals, synthetic materials and, in particular, steels, polyamide 6, polyamide 6.6 or PBT might be considered. Structures which achieve the desired energy characteristic by kinking, are made of these materials. A use of these materials allows the energy characteristic to be adjusted in a reproducible manner.

In a further embodiment of the invention, the ribs of the structure, which crumble or kink in the event of a collision, are separated from one another by hollow cavities. In this case, the spacing distance between two ribs disposed adjacent to one another may be at least as wide as the ribs are high. The spacing distance between two ribs disposed adjacent to one another is at least twice as wide as the ribs are high. This ensures that sufficient free space remains between the ribs, so that the material of the ribs can either kink away to the sides or so that sufficient space is available to accommodate the crumbling or splintering material, in order to obtain the desired, early energy transfer and the decline in the transfer curve after reaching a maximum after a collision.

In a further embodiment of the invention, ribs of the structure are separated from one another by readily-compressible foams or sponges. As a result of the compressibility, the free space described above in the context of a kinking or crumbling is provided by the compression of the sponge or foam. At the same time, the adapter also provides an insulating function. In this manner, it can contribute to noise insulation, especially, if the adapter is adjacent to an engine hood.

In a further embodiment, the adapter is used exclusively at positions, in which the free space distance, without the provision of the adapter between the vehicle bodywork and an internal vehicle component disposed adjacent to the bodywork, is up to 7 centimetres. It has been shown, that with free space distances of greater than 7 centimetres, the flexibility of the vehicle bodywork is generally sufficient to achieve low HIC-values.

In another embodiment of the invention, the remaining free space distance between the vehicle bodywork and an adjacent, internal vehicle component may be reduced to 10 mm, preferably to 7 mm. It has been shown that if this maximum free space distance is observed, the desired energy-absorption curve is achieved, thereby significantly reducing the HIC-value.

In another embodiment of the invention, the free space distance is not reduced to zero, but a free space distance of preferably at least 5 mm is deliberately provided. It has been shown that, on the one hand, if a very small free space distance is provided, a significant reduction of the HIC-value is still achieved. On the other hand, relatively minor collisions do not accidentally lead to a kinking or crumbling of a structure of the adapter, which may possibly remain unnoticed from the outside. The total potential risk would be increased unless a small free space distance is deliberately provided.

In one embodiment, particularly in order to reduce the free space distance as desired, the adapter is adapted above and/or below to the shape and the characteristic of the respectively-adjacent vehicle component. In one embodiment, its external shape relative to an adjacent engine block corresponds to the shape of the adjacent part of the engine block. Correspondingly, the shape of the adapter relative to the vehicle bodywork corresponds to the shape or the contour of the vehicle body work.

In one embodiment, the rib structure of the adapter is between 20 and 50 mm high, by preference at least 35 mm high. Material of at least 20 to 50 mm in height is therefore available for crumbling or respectively kinking.

In one embodiment of the invention, the adapter is attached directly to the vehicle component. This is particularly advantageous, if the adapter also adjoins an engine hood. The handling of the engine hood is not undesirably hampered by the adapter.

If a part of the vehicle bodywork, which is not a component of a folding door, is involved, the adapter may also be attached to the vehicle bodywork, because this can generally be realised in a technically simple manner.

In one embodiment of the invention, an adapter is adjacent to an engine hood primarily because collisions between persons and engine hoods are particularly dangerous.

Accordingly, the use of an adapter considerably reduces the potential risk for a pedestrian in a technically-simple and safe manner. Furthermore, the provision of an adapter achieves a passive protection in a cost-favourable manner, in spite of the fact that the geometries within a motor vehicle are always different, for example, because of the difference in engines. The adapter may require relatively little structural space.

In a further embodiment of the invention, the vehicle bodywork additionally provides a rib structure like the adapter, in particular, instead of stays provided for stabilisation. This supports a reduction of the HIC-value. This rib structure may also be evenly distributed over the surface area which could injure a pedestrian.

Moreover, the invention relates to a structure of a front hood for a motor vehicle, wherein the front hood provides a structure for reducing the HIC-value, which is crumbled or splintered and/or kinked or folded in the event of a collision of a head with the front hood, and wherein the structure is formed by ribs.

The structure may provide the above-named features of the adapter individually or in combination with one another.

The invention is explained below with reference to the Figures, in which:

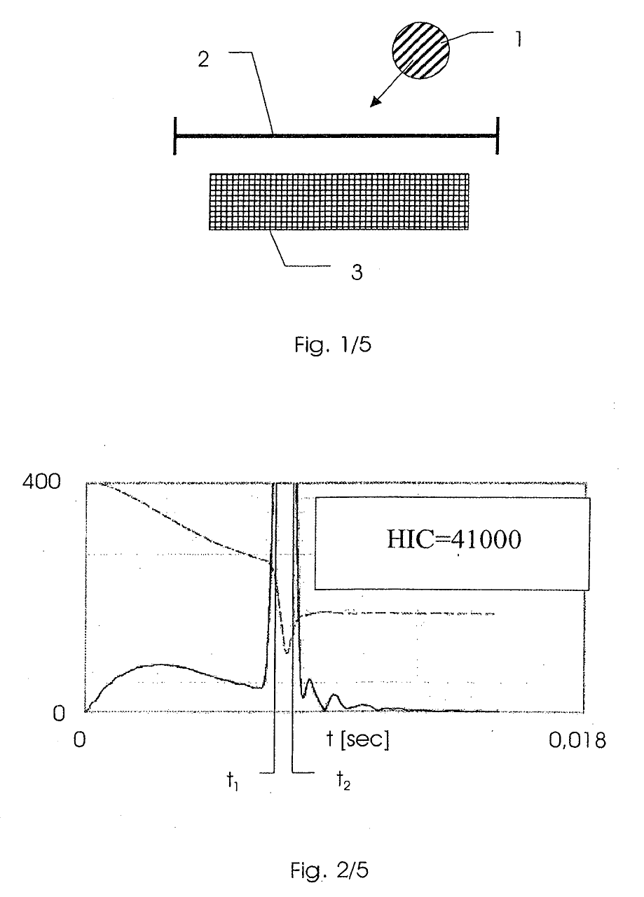

FIG. 1 is a diagram of a vehicle structure according to the prior art;

FIG. 2 is a graph of velocity and acceleration relating to FIG. 1;

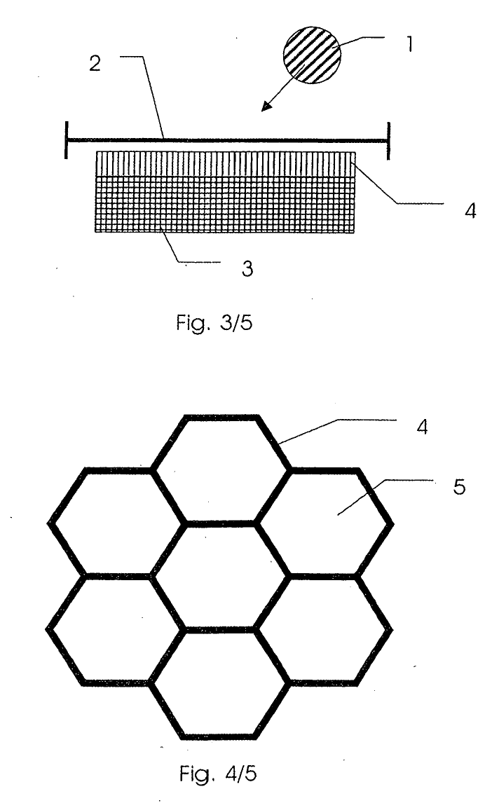

FIG. 3 is a diagram of a vehicle structure according to the invention;

FIG. 4 is a diagram of the adaptor of FIG. 4; and

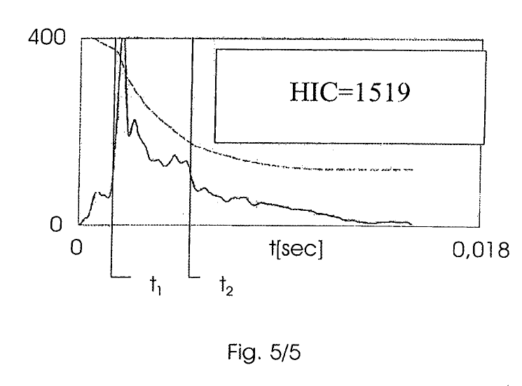

FIG. 5 is a graph similar to FIG. 2 but relating to FIG. 3.

FIGS. 3 to 5 show an exemplary embodiment, to which the invention is not restricted.

A first structure corresponding to the prior art was simulated by computer. A head 1 provides a weight of 4.8 kg. The head strikes a clamped metal sheet 2, which is flexible by comparison with the vehicle component 3 disposed inside the bodywork, at a velocity of 35 kilometres per hour. The metal sheet 2 consists of steel 0.7 mm thick and is a part of the vehicle bodywork. The non-flexible, rigid vehicle component 3 is disposed behind the metal sheet in the interior of the vehicle bodywork. The free space distance between the vehicle component 3 and the metal sheet 2 is 55 mm.

The computer simulation showed an HIC-value of 41,000. The broken line in FIG. 2 indicates the time characteristic for the velocity of the head. The velocity in [km/h*10] is plotted against time t in [sec]. The continuous line plotted as the function in FIG. 2 illustrates the acceleration of the head 1 during the collision. The acceleration in [g=9.81 m/s²] is plotted against time t in [sec]. Moreover, the integration limits t₁ and t₂ for determining the HIC-value are indicated as vertical lines in FIG. 2. The integration limits are obtained from the formula provided in introduction. The limits t₁ and t₂ are calculated in such a manner that a maximum HIC-value is obtained in the resulting time window. The resulting HIC-value is 41,000.

The second structure shown in FIG. 3 relates to the present invention. By way of difference from the situation shown in FIG. 1, an adapter 4 formed by ribs for the reduction of the HIC-value is fitted between the rigid, non-flexible vehicle component 3 and the clamped, flexible metal sheet 2, which is, in fact, attached to the vehicle component 3. FIG. 4 shows a plan view of the ribs, which extend in a honeycomb shape. Hollow cavities 5, which can, however, advantageously be filled with sound absorbing materials remain between the ribs. Each rib of a hexagonal honeycomb is 3.2 mm thick, 45 mm high and 145 mm long. Each rib is made of PA6 GF30. A free space distance of 10 mm remains between the structure 4 and the vehicle component 3.

The graph in FIG. 5 corresponds to the graph from FIG. 2. This graph shows the velocity of the head 1 during the collision as a broken line, which is plotted against time t in seconds. The continuous line or the function shows the characteristic for the acceleration. By way of distinction from the situation shown in FIG. 2, the velocity of the head is reduced continuously when the head strikes the metal sheet. As a result, a substantially more favourable HIC-value of 1519 is achieved, which, inter alia, falls below the required threshold of 2000 in spite of the presence of a vehicle component.

What is claimed is:

1. A motor vehicle with a vehicle bodywork and a vehicle component disposed within the vehicle bodywork, wherein an adapter is disposed between said vehicle component and said vehicle bodywork in order to reduce the HIC-value.

2. A motor vehicle according to claim 1, wherein said adapter comprises a structure, which is crumbled, splintered, kinked and/or folded in the event of a collision.

3. A motor vehicle according to claim 1, wherein said adapter provides ribs, which are formed substantially at right angles to the adjacent vehicle bodywork.

4. A motor vehicle according to claim 3, wherein said ribs consist of a material, which provides a ductile yield up to 10%, advantageously up to 5%.

5. A motor vehicle according to any claim 3, wherein said ribs consist of a material, which provides a ductile yield of more than 50%.

6. A motor vehicle according to claim 3, wherein said adapter provides a plurality of ribs, adjacent said ribs being separated from one another by hollow cavities.

7. A motor vehicle according to claim 6, wherein said adapter provides a plurality of ribs, adjacent said ribs being separated from one another by foams or sponges.

8. A motor vehicle according to claim 1, wherein said adapter is used exclusively where the otherwise free space distance between said vehicle bodywork and said internally-disposed vehicle component is less than 7 centimetres.

9. A motor vehicle according to claim 1, wherein the free space distance between said vehicle bodywork and said vehicle component remaining as a result of said adapter is between 5 and 10 millimetres.

10. A motor vehicle according to claim 1, wherein said adapter comprises a rib structure 20 to 50 mm in height, by preference, at least 35 mm in height.

11. A motor vehicle according to claim 1, wherein said adapter comprises a plurality of evenly-distributed ribs.

12. A motor-vehicle according to claim 1, wherein said adapter is attached to a said internally-disposed vehicle component.

13. A motor vehicle according to claim 1, wherein said vehicle bodywork disposed adjacent to said adapter is an engine hood.

14. A hood for a motor vehicle, wherein said hood provides a structure for reducing the HIC-value, said structure being crumbled or splintered and/or kinked or folded in the event of an impact of a head against said hood, said structure being formed by ribs.
